(19) United States
(12) Patent Application Publication
(10) Pub. No.: US 2025/0129644 A1
(43) Pub. Date: Apr. 24, 2025

(54) SINGLE-HAND LATCH MECHANISM WITH SLAM CLOSE

(71) Applicant: Decked LLC., Ketchum, ID (US)

(72) Inventors: William Banta, Ketchum, ID (US); Spencer Robert Dahl, Sun Valley, ID (US); Samuel Quintrell. Wood, Ketchum, ID (US); James Calvin Allan, Ketchum, ID (US); Shaun Christopher. Muston, South Lyon, MI (US); Jordan Daniel. Lanning, Boise, ID (US); John Mason. MacArthur, Roseville, MI (US)

(21) Appl. No.: 18/736,989

(22) Filed: Jun. 7, 2024

Related U.S. Application Data
(60) Provisional application No. 63/592,541, filed on Oct. 23, 2023.

(51) Int. Cl. E05C 1/16; B25H 3/02; B65D 25/28; B65D 43/16; B65D 43/22; E05C 1/00

(52) U.S. Cl. CPC E05C 1/166; B25H 3/02; B65D 25/2858; B65D 43/163; B65D 43/22; E05C 1/004

(57) ABSTRACT

An apparatus is provided that includes a base defining a cavity; a lid coupled to the base; a latch; and a resilient member. The lid is pivotable between a first state in which the cavity is enclosed and a second state in which the cavity is exposed. The latch includes a first portion, a second portion, and a third portion. Each of the second and third portions interact with the base when the lid is in the first position so as to discourage the lid from transitioning to the second state. The resilient member is disposed between the latch and the lid such that moving the first portion of the latch so as to compress the resilient member moves each of the second and third portions of the latch away from the base.

### PRIORITY CLAIM

The present application claims priority to and the benefit of U.S. Provisional Application 63/592,541, filed Oct. 23, 2023, the entirety of which is herein incorporated by reference.

### TECHNICAL FIELD

The present application relates generally to containers. More specifically, the present application provides a latch mechanism for a container.

### BACKGROUND

Containers typically include a base forming a cavity and a lid. The lid can be removed from the base, or moved relative to the base, to enable access to the cavity. Some containers include a mechanism, such as a latch mechanism, that maintains the lid in a position such that the cavity remains enclosed by the lid. The latch mechanism can reduce the likelihood that the contents within the cavity unintentionally escape the container's confines.

### SUMMARY

The present disclosure provides an apparatus with a new and innovative latch mechanism that locks and unlocks a container's lid from the container's base. A user needs only one hand to transition the latch mechanism from a resting position to a triggered position and thereafter rotate the container's lid away from the container's base to open the container. In this way, a user can unlock and open the container all in one fluid motion. To close the container, a user simply releases the lid to let the lid slam closed. In the action of the lid slamming closed, the latch mechanism freely transitions such that the lid is locked to the base by the latch mechanism after the lid closes. In this way, a user can access the cavity within the container, obtain an item from within the cavity, and close the container all with one hand.

In an example, an apparatus includes a base defining a cavity; a lid coupled to the base; a latch; and a resilient member. The lid is movable between a first position in which the cavity is enclosed and a second position in which the cavity is exposed. The latch includes a first portion, a second portion including a first locking member, and a third portion including a second locking member. Each of the first and second locking members engage the base when the lid is in the first position so as to prevent the lid from transitioning to the second position. The resilient member is disposed between the latch and the lid such that moving the first portion of the latch so as to compress the resilient member moves each of the second and third portions of the latch away from the base.

In another example, an apparatus includes a base defining a cavity, a lid coupled to the base and pivotable between a first state and a second state, and a latch. The latch is coupled to the lid and movable between a first position and a second position such that the latch is configured to, with the lid in the first state, lock or unlock the lid relative to the base. The latch is biased towards the first position and movable in a direction parallel with a length of the lid. The latch includes a first portion, a second portion extending from the first portion, and a third portion extending from the first portion. The second and third portions are configured to be able to contact the base when the latch is in the first position.

In another example, a method includes transitioning a first portion of a latch of a container from a first position to a second position of the latch such that second and third portions of the latch are moved away from a base of the container. The second and third portions extend from the first portion. The latch is coupled to a lid of the container and is biased towards the first position. The lid is coupled to the base of the container. The method further includes pivoting, with the latch in the second position, the lid from a first state to a second state. The lid in the first state encloses a cavity of the base and the lid in the second state exposes the cavity. The method further includes releasing the lid in the second state thereby allowing the lid to pivot to the first state with the latch in the first position.

In some aspects, the apparatus or container of any of the above examples may be a tool box.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a container that has a latch mechanism, according to an aspect of the present disclosure.

FIG. 2 is a perspective view of the container with a handle in a stowed position, according to an aspect of the present disclosure.

FIG. 3 is a top view of the container, according to an aspect of the present disclosure.

FIG. 4A is a magnified portion of FIG. 3 illustrating the latch mechanism in a locked position, according to an aspect of the present disclosure.

FIG. 4B is a is a magnified portion of FIG. 3 illustrating the latch mechanism in an unlocked position, according to an aspect of the present disclosure.

FIG. 5 is a perspective view of the container in an open state, according to an aspect of the present disclosure.

FIG. 6 is a perspective view of a latch of the latch mechanism, according to an aspect of the present disclosure.

FIG. 7 is an exploded view of the latch, according to an aspect of the present disclosure.

FIG. 8 is a magnified top view of a trigger portion of the latch coupled to a locking portion of the latch, according to an aspect of the present disclosure

FIG. 9 is a side view of a locking portion of the latch, according to an aspect of the present disclosure.

FIG. 10 is a cross-sectional view of the container illustrating the latch mechanism, according to an aspect of the present disclosure.

FIG. 11 is a flow chart of a method for opening and closing a container, according to an aspect of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case.

An apparatus (e.g., container) with a new and innovative latch mechanism that locks and unlocks a lid of the container from the a base of the container is provided. The latch mechanism enables a user to easily unlatch, open, close, and latch the lid in one fluid motion using only a single hand, which frees the user's other hand to retrieve an item from within the container. For example, a user needs only one hand to transition the latch mechanism from a resting position to a triggered position and thereafter rotate the container's lid away from the container's base to open the container. In this way, a user can unlock and open the container all in one fluid motion.

To close the container, a user simply releases the lid to let the lid slam closed. In the action of the lid slamming closed, the latch mechanism freely transitions such that the lid is locked to the base by the latch mechanism after the lid closes. In this way, a user can access the cavity within the container, obtain an item from within the cavity, and close the container all with one hand. For example, the container may be a toolbox and the user may unlatch and open the lid with one hand, retrieve a tool from the container with a second hand, and let the lid close and latch on its own without having to put the tool down.

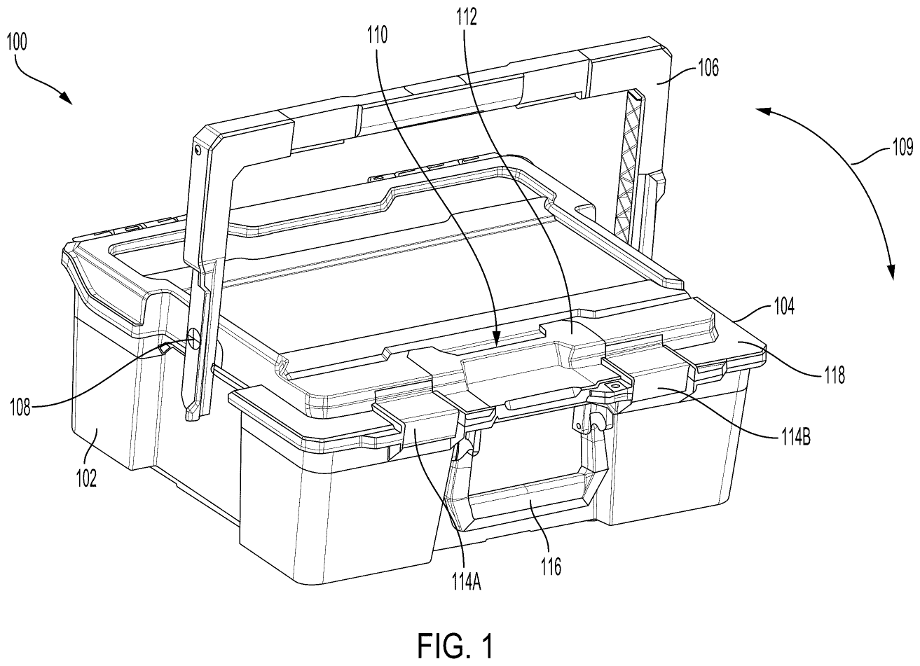

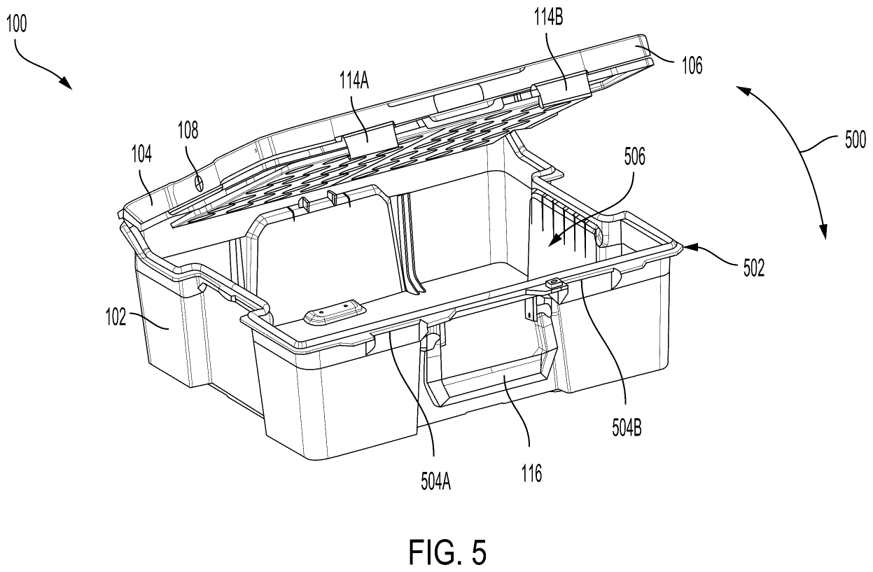

FIGS. 1 to 3 show various view of an example container 100. Container 100 includes a base 102 coupled to a lid 104. For example, lid 104 may be coupled to base 102 by way of hinges 200A, 200B or another suitable configuration. With reference to FIG. 5, base 102 defines a cavity 506. Lid 104 is pivotable about hinges 200A, 200B such that lid 104 can move along double-sided arrow 500 between a first state (e.g., closed state, see FIG. 1) in which cavity 506 is enclosed by lid 104 and a second state (e.g., open state, see FIG. 5) in which cavity 506 is exposed.

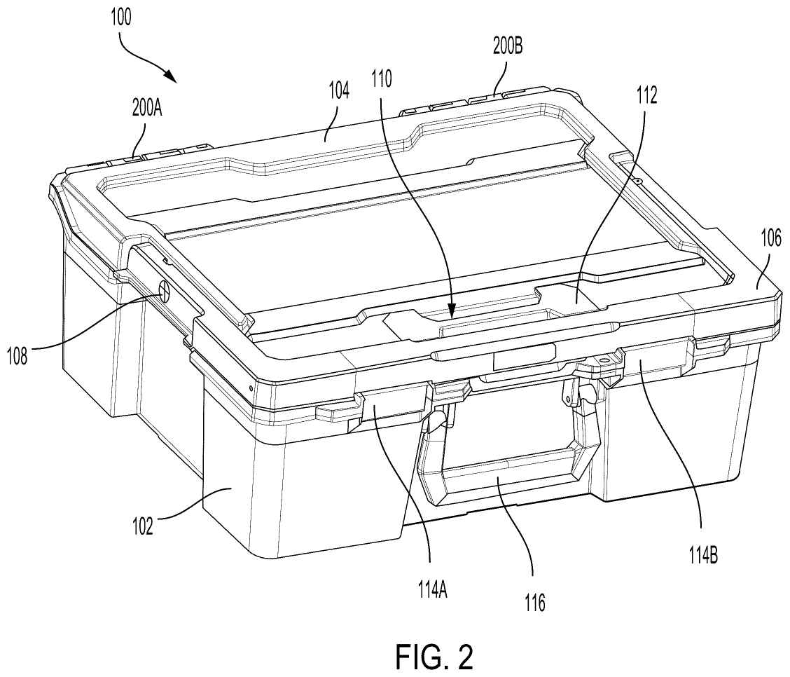

Returning to FIGS. 1 to 3, a handle 106 is pivotably coupled to lid 104 at pivot point 108. Handle 106 may pivot between a first position (e.g., carrying position) shown in FIG. 1 in which handle 106 may be used to carry container 100 and a second position (e.g., stowed position) shown in FIG. 2 in which handle 106 is stowed. In various aspects, such as the illustrated aspect, lid 104 may include an edge 118 structured to accept handle 106 in the stowed position. Stated differently, handle 106 may form a portion of lid 104 when in the stowed position. In some aspects, handle 106 may include a locking mechanism to maintain handle 106 in the first position or in the second position. In some aspects, handle 106 may additionally or alternatively be coupled to base 102. In some aspects, handle 106 may be omitted. Container 100 additionally includes a handle 116 that is pivotably coupled to base 102 in the illustrated aspect. In some aspects, handle 116 may be omitted.

Container 100 further includes a latch mechanism capable of locking and unlocking movement of lid 104 relative to base 102. The latch mechanism includes a latch 110. Latch 110 may be coupled to lid 104. Latch 110 includes a first portion 112 (e.g., a trigger portion), a second portion 114A (e.g., a locking portion), and a third portion 114B (e.g., a locking portion). Each of the locking portions 114A, 114B extends from the trigger portion 112.

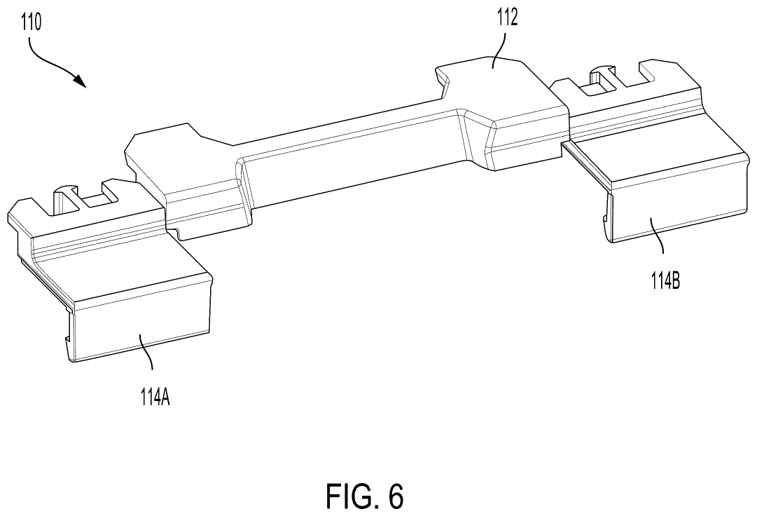

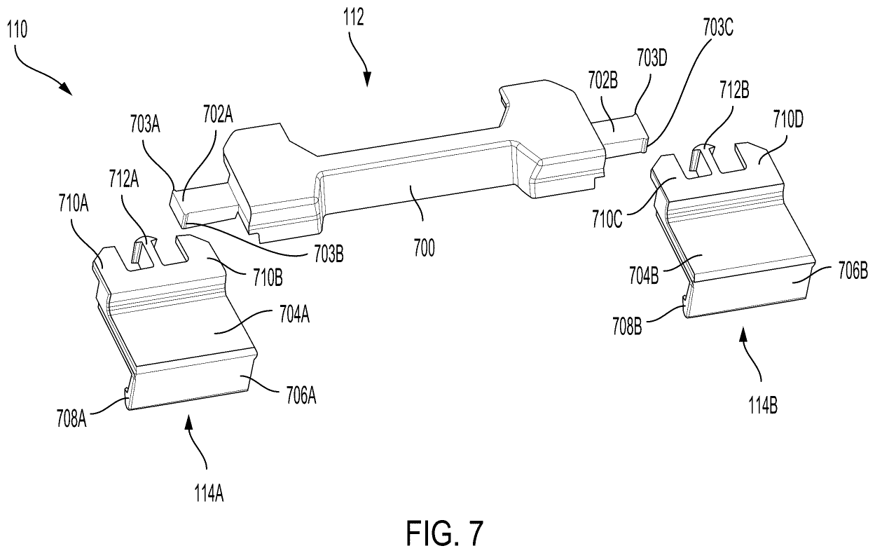

FIGS. 6 and 7 are, respectively, a perspective and exploded view of latch 110 in isolation. Trigger portion 112 is coupled to each of locking portions 114A, 114B. For instance, trigger portion 112 includes a body 700 and coupling members 702A, 702B extending from body 700. Each of coupling members 702A, 702B may include at least one protrusion 703A, 703B, 703C, 703D extending from each of coupling members 702A, 702B. Locking portions 114A, 114B include members 704A, 704B at an angle (e.g., 90 degrees) to members 706A, 706B. Extending from members 704A, 704B are coupling members 710A, 710B, 710C, 710D, 712A, 712B.

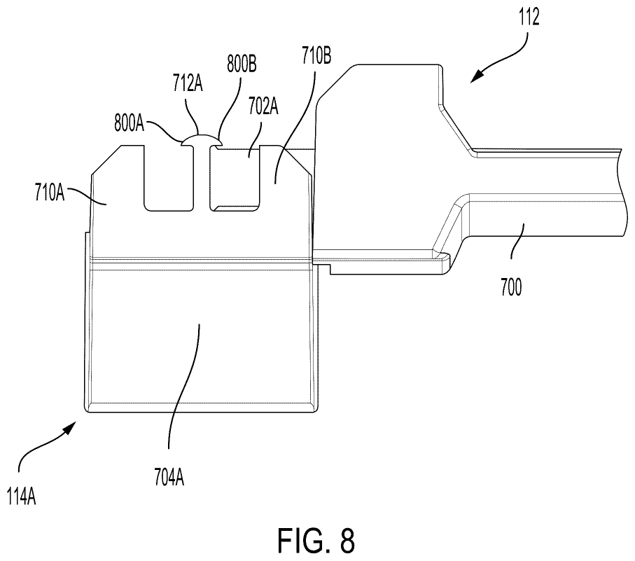

FIG. 8 shows a magnified view of locking portion 114A coupled to trigger portion 112. Each of coupling members 712A, 712B includes at least one protrusion 800A, 800B extending from coupling members 712A, 712B. Coupling member 702A is coupled to locking portion 114A via coupling members 710B, 712A. For example, protrusion 800B may engage protrusion 703A. In another example, coupling member 710B may contact coupling member 702A.

In some aspects, protrusion 800A and coupling member 710A may be used to couple a second trigger portion 112 to locking portion 114A. For example, the size of container 100 may make two trigger portions 112 beneficial. In some aspects, one or both of protrusion 800A and coupling member 710A may be omitted. It will be appreciated that other suitable coupling structures or mechanisms may be utilized between trigger portion 112 and locking portions 114A, 114B. In other aspects, trigger portion 112 may be integral with one or both of locking portions 114A, 114B.

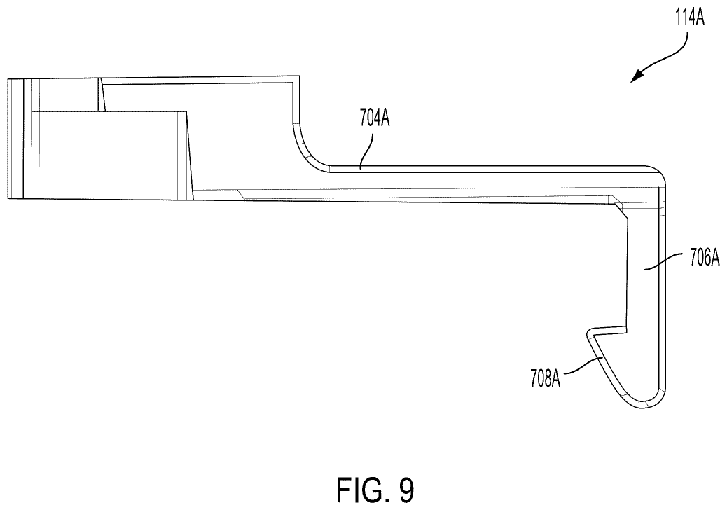

With reference to FIGS. 7 and 9, latch 110 includes protrusions 708A, 708B (e.g., locking members) that protrude from members 706A, 706B, respectively. Referring to FIG. 5, the latch mechanism further includes protruding edges 504A, 504B of base 102. As will be described in more detail below, locking members 708A, 708 may be able to contact, or may be moved to avoid contact with, protruding edges 504A, 504B.

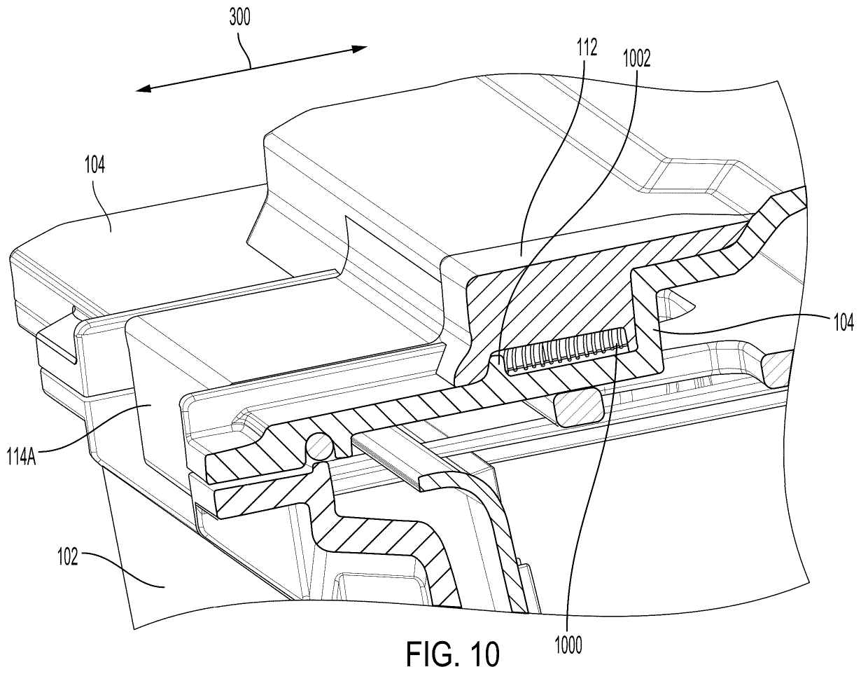

Referring to FIG. 10, the latch mechanism of container 100 further includes a resilient member 1000. Resilient member 1000 may be a coil spring, other suitable springs, or other suitable resilient and deformable components that can store and release mechanical energy. A first end of resilient member 1000 is in contact with trigger portion 112 whereas a second end of resilient member 1000 is in contact with a protruding portion 1002 of lid 104. Protruding portion 1002 forms another portion of the latch mechanism. As such, the latch mechanism in the illustrated aspect includes latch 110, resilient member 1000, protruding portion 1002 of lid 104, and protruding edges 504A, 504B of base 102.

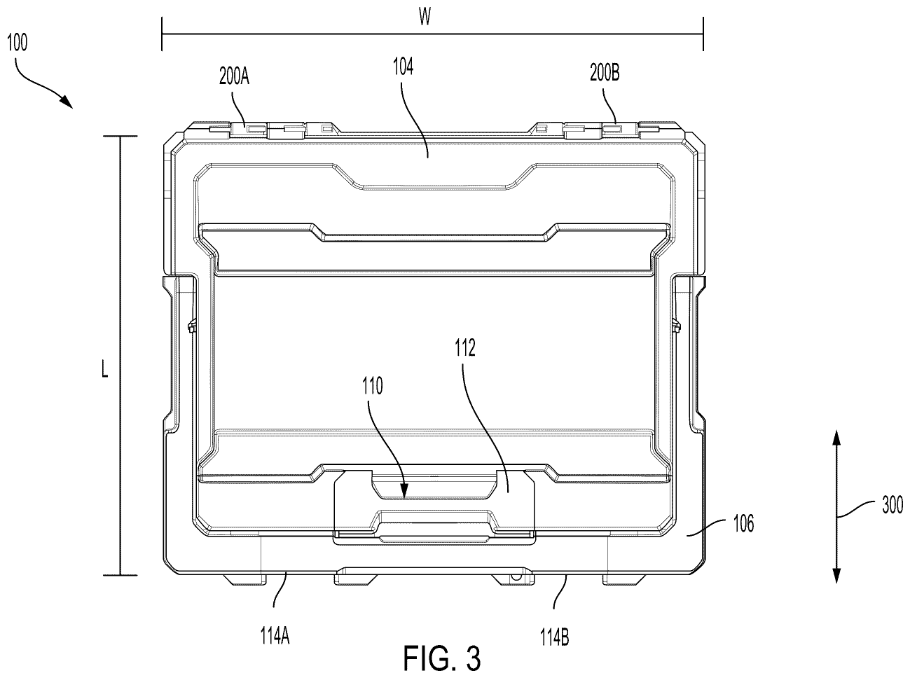

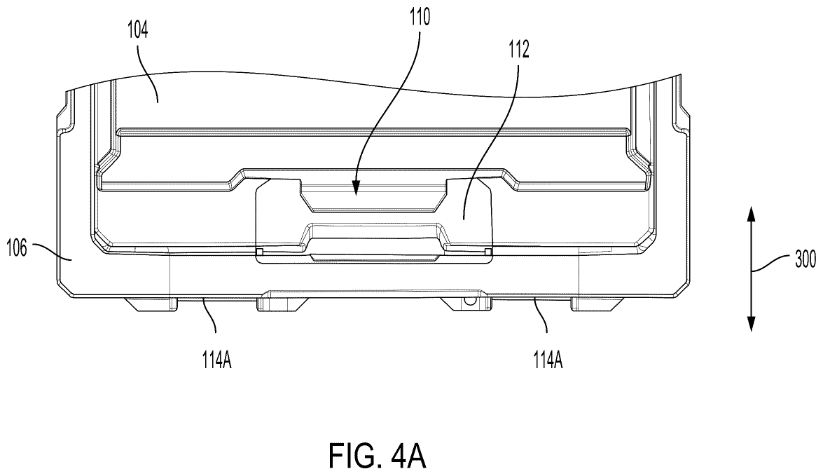

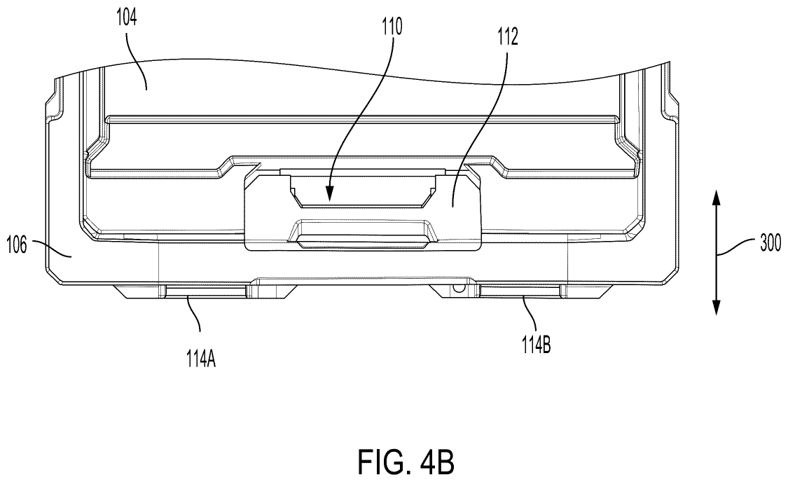

Operation of the latch mechanism will now be described. As described, the latch mechanism is capable of locking and unlocking movement of lid 104 relative to base 102. With reference to FIG. 3, latch 110 is movable in the directions of double-sided arrow 300 between a first position in which latch 110 is at rest and a second position in which latch 110 is triggered. Stated differently, container 100 includes a width W and a length L and latch 110 is movable in a direction parallel to the length L. Trigger portion 112 moves in tandem with locking portions 114A, 114B. For example, FIG. 4A shows a magnified view of latch 110 in the resting position, whereas FIG. 4B shows a magnified view of latch 110 in the triggered position. A comparison between FIGS. 4A and 4B shows that trigger portion 112 is closer to handle 106, and the ends of locking portions 114A, 114B are further from handle 106, in FIG. 4B than in FIG. 4A.

With lid 104 in the closed state, latch 110 being in the resting position discourages lid 104 from pivoting away from base 102 thereby keeping cavity 506 enclosed by lid 104, whereas latch 110 being in the triggered position allows for opening lid 104 to expose cavity 506. For instance, when lid 104 is in the closed state and latch 110 is in the resting position, protruding edges 504A, 504B of base 102 discourage lid 104 from opening by locking members 708A, 708B of latch 110 contacting protruding edges 504A, 504B. Conversely, with latch 110 transitioned to the triggered position, locking members 708A, 708B no longer contact protruding edges 504A, 504B as lid 104 is pivoted and lid 104 can thereby be moved to the open state.

In an example, a user may effectuate the movement of latch 110 from the resting position to the triggered position by gripping both trigger portion 112 and handle 106 with their hand (e.g., fingers on trigger portion 112 and palm on handle 106) and squeezing trigger portion 112 towards handle 106. If the user were to release trigger portion 112 while in the triggered position, trigger portion 112 and locking portions 114A, 114B of latch 110 would return to the resting position. For instance, in the arrangement shown in FIG. 10, resilient member 1000 biases trigger portion 112 of latch 110 towards the resting position of latch 110. When a user squeezes trigger portion 112, resilient member 1000 is compressed and stores energy. When the user releases trigger portion 112, resilient member 1000 releases the stored energy and forces latch 110 back to the resting position.

When lid 104 is in the open state, the user may maintain latch 110 in the triggered position or may release latch 110 into the resting position. In either scenario, the user may close and latch lid 104 from the open state by releasing lid 104 and allowing gravity to pivot lid 104 to the closed state. Stated differently, lid 104 may slam closed and become latched by latch 110 without any assistance from the user. For instance, when lid 104 is released from the open state, locking members 708A, 708B of latch 110 contact protruding edges 504A, 504B of base 102, which force locking portions 114A, 114B away from base 102 and into the triggered position in order to create space for locking members 708A, 708B to pass protruding edges 504A, 504B. Forcing locking portions 114A, 114B away from base 102 further causes compression of resilient member 1000, which stores energy.

When locking members 708A, 708B are past, and no longer contact, protruding edges 504A, 504B, resilient member 1000 releases the stored energy and forces latch 110 back into the resting position such that lid 104 is locked in the closed state by latch 110. In this way, container 100 enables a user to easily unlatch, open, close, and latch lid 104 using only a single hand, which frees the user's other hand to retrieve an item from within container 100.

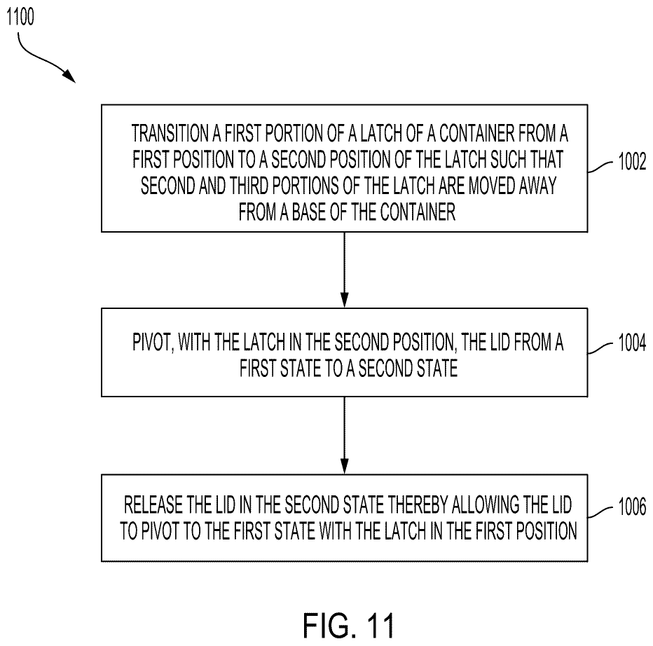

FIG. 11 is a flow chart of a method 1100 for opening and closing a container (e.g., container 100). Method 1100 includes, at block 1102, transitioning a first portion (e.g., trigger portion 112) of a latch (e.g., latch 110) of the container 100 from a first position (e.g., resting position) to a second position (e.g., triggered position) of the latch 110 such that second and third portions (e.g., locking portions 114A, 114B) of the latch 110 are moved away from a base (e.g., base 102) of the container 100. The locking portions 114A, 114B each extend from the first portion 112. The latch 110 is coupled to a lid (e.g., lid 104) of the container 100 and is biased towards the resting position. The lid 104 is coupled to the base 102 of the container 100.

In various aspects, with the latch 110 in the resting position, the locking portions 114A, 114B of the latch 110 are each able to contact the base 102. In various aspects, transitioning the trigger portion 112 of the latch 110 from the resting position to the triggered position includes forcing the trigger portion 112 towards a handle (e.g., handle 106) of the container 100. In such aspects, the handle 106 is pivotable relative to the lid 104.

At block 1104, with the latch 110 in the triggered position, the lid 104 is pivoted from a first state (e.g., closed state) to a second state (e.g., open state). The lid 104 in the closed state encloses a cavity (e.g., cavity 506) of the base 102 and the lid 104 in the open state exposes the cavity 506.

At block 1106, the lid 104 in the open state is released thereby allowing the lid 104 to pivot to the closed state with the latch in the resting position. In various aspects, the lid 104 pivoting to the closed state with the latch 110 in the resting position includes the latch 110 transitioning, without user input, from the resting position to the triggered position and back to the resting position.

It is noted that the order of one or more blocks (or operations) described with reference to FIG. 11 may be changed, certain blocks may be combined with other blocks, additional blocks may be added, and some of the block may be omitted.

In one or more aspects, the present apparatus may include additional aspects, such as any single aspect or any combination of aspects described below or in connection with one or more other processes or devices described elsewhere herein. In a first aspect, an apparatus includes a base defining a cavity; a lid coupled to the base; a latch; and a resilient member. The lid is movable between a first position in which the cavity is enclosed and a second position in which the cavity is exposed. The latch includes a first portion, a second portion including a first locking member, and a third portion including a second locking member. Each of the first and second locking members engage the base when the lid is in the first position so as to prevent the lid from transitioning to the second position. The resilient member is disposed between the latch and the lid such that moving the first portion of the latch so as to compress the resilient member moves each of the second and third portions of the latch away from the base.

In a second aspect, in combination with the first aspect, the latch is movable between a first position and a second position, and the second and third portions of the latch are further from the base in the second position than the first position.

In a third aspect, in combination with the second aspect, the resilient member biases the latch towards the first position.

In a fourth aspect, in combination with one or more of the first aspect through the third aspect, the first portion of the latch moves in a same direction as the second and third portions of the latch.

In a fifth aspect, in combination with the fourth aspect, with the lid in the first state, the direction is parallel with a length of the lid.

In a sixth aspect, in combination with one or more of the first aspect through the fifth aspect, the first portion of the latch is coupled to each of the second portion and the third portion.

In a seventh aspect, in combination with one or more of the first aspect through the sixth aspect, the second portion of the latch includes a first member extending from the first portion of the latch and a second member extending at an angle from the first member. The third portion of the latch includes a third member extending from the first portion of the latch and a fourth member extending at an angle from the third member.

In an eighth aspect, in combination with one or more of the first aspect through the seventh aspect, the apparatus further includes a handle pivotable relative to the lid between a carrying position and a stowed position.

In a ninth aspect, in combination with the eighth aspect, the lid includes an edge configured to receive the handle in the stowed position.

In a tenth aspect, in combination with one or more of the first aspect through the ninth aspect, the apparatus is a tool box.

In an eleventh aspect, an apparatus includes a base defining a cavity, a lid coupled to the base and pivotable between a first state and a second state, and a latch. The latch is coupled to the lid and movable between a first position and a second position such that the latch is configured to, with the lid in the first state, lock or unlock the lid relative to the base. The latch is biased towards the first position and movable in a direction parallel with a length of the lid. The latch includes a first portion, a second portion extending from the first portion, and a third portion extending from the first portion. The second and third portions are configured to be able to contact the base when the latch is in the first position.

In a twelfth aspect, in combination with the eleventh aspect, the latch is configured such that, when the lid is in the second state, releasing the lid from the second state results in the lid being in the first state and the latch being in the first position.

In a thirteenth aspect, in combination with one or more of the eleventh aspect through the twelfth aspect, the latch is biased towards the first position by a spring disposed between the latch and a portion of the lid.

In a fourteenth aspect, in combination with one or more of the eleventh aspect through the thirteenth aspect, the second portion of the latch includes a first protrusion extending towards the base, and the third portion of the latch includes a second protrusion extending towards the base.

In a fifteenth aspect, in combination with the fourteenth aspect, the second portion includes a first member extending from the first portion of the latch and a second member extending at an angle from the first member, and the second member includes a first protrusion.

In a sixteenth aspect, in combination with the fourteenth aspect, the base includes a first protruding edge and a second protruding edge. When the latch is in the first position, the first protrusion of the second portion of the latch is able to contact the first protruding edge and the second protrusion of the second portion of the latch is able to contact the second protruding edge.

In a seventeenth aspect, a method includes transitioning a first portion of a latch of a container from a first position to a second position of the latch such that second and third portions of the latch are moved away from a base of the container. The second and third portions extend from the first portion. The latch is coupled to a lid of the container and is biased towards the first position. The lid is coupled to a base of the container. The method further includes pivoting, with the latch in the second position, the lid from a first state to a second state. The lid in the first state encloses a cavity of the base and the lid in the second state exposes the cavity. The method further includes releasing the lid in the second state thereby allowing the lid to pivot to the first state with the latch in the first position.

In an eighteenth aspect, in combination with the seventeenth aspect, with the latch in the first position, the second and third portions of the latch are each able to contact the base.

In a nineteenth aspect, in combination with one or more of the seventeenth aspect through the eighteenth aspect, transitioning the first portion of the latch from the first position to the second position includes forcing the first portion towards a handle of the container, wherein the handle is pivotable relative to the lid.

In a twentieth aspect, in combination with one or more of the seventeenth aspect through the nineteenth aspect, the lid pivoting to the first state with the latch in the first position includes the latch transitioning, without user input, from the first position to the second position and back to the first position.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The above specification provides a complete description of the structure and use of illustrative embodiments of this disclosure. Although certain embodiments have been described above with a certain degree of particularity, or with reference to one or more individual embodiments, the scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The invention is claimed as follows:

1. An apparatus comprising:
a base defining a cavity;
a lid coupled to the base and pivotable between a first state in which the cavity is enclosed by the lid and a second state in which the cavity is exposed;
a latch comprising a first portion, a second portion, and a third portion, wherein each of the second and third portions interact with the base when the lid is in the first state so as to discourage the lid from transitioning to the second state; and
a resilient member disposed between the latch and the lid such that moving the first portion of the latch so as to compress the resilient member moves each of the second and third portions of the latch away from the base.

2. The apparatus of claim 1, wherein the latch is movable between a first position and a second position, wherein the second and third portions of the latch are further from the base in the second position than the first position.

3. The apparatus of claim 2, wherein the resilient member biases the latch towards the first position.

4. The apparatus of claim 1, wherein the first portion of the latch moves in a same direction as the second and third portions of the latch.

5. The apparatus of claim 4, wherein, with the lid in the first state, the direction is parallel with a length of the lid.

6. The apparatus of claim 1, wherein the first portion of the latch is coupled to each of the second portion and the third portion.

7. The apparatus of claim 1, wherein the second portion of the latch includes a first member extending from the first portion of the latch and a second member extending at an angle from the first member, and wherein the third portion of the latch includes a third member extending from the first portion of the latch and a fourth member extending at an angle from the third member.

8. The apparatus of claim 1, further comprising a handle pivotable relative to the lid between a carrying position and a stowed position.

9. The apparatus of claim 8, wherein the lid includes an edge configured to receive the handle in the stowed position.

10. The apparatus of claim 1, wherein the apparatus is a tool box.

11. An apparatus comprising:
a base defining a cavity;
a lid coupled to the base and pivotable between a first state and a second state; and
a latch coupled to the lid and movable between a first position and a second position such that the latch is configured to, with the lid in the first state, lock or unlock the lid relative to the base,
wherein the latch is biased towards the first position and movable in a direction parallel with a length of the lid,
wherein the latch includes a first portion, a second portion extending from the first portion, and a third portion extending from the first portion, and
wherein the second and third portions are configured to be able to contact the base when the latch is in the first position.

12. The apparatus of claim 11, wherein the latch is configured such that, when the lid is in the second state, releasing the lid from the second state results in the lid being in the first state and the latch being in the first position.

13. The apparatus of claim 11, wherein the latch is biased towards the first position by a spring disposed between the latch and a portion of the lid.

14. The apparatus of claim 11, wherein the second portion of the latch includes a first protrusion extending towards the base, and the third portion of the latch includes a second protrusion extending towards the base.

15. The apparatus of claim 14, wherein the second portion includes a first member extending from the first portion of the latch and a second member extending at an angle from the first member, and wherein the second member includes a first protrusion.

16. The apparatus of claim 14, wherein the base includes a first protruding edge and a second protruding edge, and
wherein, when the latch is in the first position, the first protrusion of the second portion of the latch is able to contact the first protruding edge and the second protrusion of the second portion of the latch is able to contact the second protruding edge.

17. A method comprising:
transitioning a first portion of a latch of a container from a first position to a second position of the latch such that second and third portions of the latch are moved away from a base of the container, wherein the second and third portions extend from the first portion, wherein the latch is coupled to a lid of the container and is biased towards the first position, wherein the lid is coupled to the base of the container;
pivoting, with the latch in the second position, the lid from a first state to a second state, wherein the lid in the first state encloses a cavity of the base and the lid in the second state exposes the cavity; and
releasing the lid in the second state thereby allowing the lid to pivot to the first state with the latch in the first position.

18. The method of claim 17, wherein, with the latch in the first position, the second and third portions of the latch are each able to contact the base.

19. The method of claim 17, wherein transitioning the first portion of the latch from the first position to the second position includes forcing the first portion towards a handle of the container, wherein the handle is pivotable relative to the lid.

20. The method of claim 17, wherein the lid pivoting to the first state with the latch in the first position includes the latch transitioning, without user input, from the first position to the second position and back to the first position.
